(19) United States
(12) Patent Application Publication
(10) Pub. No.: US 2025/0068104 A1
(43) Pub. Date: Feb. 27, 2025

(54) IMAGE FORMING APPARATUS AND CONTROL METHOD

(71) Applicant: SHARP KABUSHIKI KAISHA, Sakai City (JP)

(72) Inventor: KAN MUKAI, Sakai City (JP)

(21) Appl. No.: 18/809,668

(22) Filed: Aug. 20, 2024

(30) Foreign Application Priority Data
Aug. 22, 2023 (JP) 2023-134301

(51) Int. Cl. G03G 15/20

(52) U.S. Cl. CPC G03G 15/2039; G03G 15/2064

(57) ABSTRACT

An image forming apparatus includes: a fixing belt; a pressure member that forms a nip portion with the fixing belt and drives the fixing belt; a heating member disposed inside the fixing belt; a fixing belt temperature detector that acquires fixing belt temperature information based on a temperature of the fixing belt; a pressure member temperature detector that acquires pressure member temperature information based on a temperature of the pressure member; and one or more controllers that determine whether or not the fixing belt is in a belt slip state where the fixing belt is not driven by movement of the pressure member, based on a relationship between the fixing belt temperature information and the pressure member temperature information.

### CROSS-REFERENCE TO RELATED APPLICATION

The present application claims priority from Japanese Application JP2023-134301, the content to which is hereby incorporated by reference into this application.

### BACKGROUND OF THE INVENTION

### 1. Field of the Invention

The present disclosure relates to an image forming apparatus, a control method thereof, and the like.

### 2. Description of the Related Art

Conventionally, an image forming apparatus that forms an image on a printing medium by using an electrophotographic system is known. Further, a method of detecting a slip of a fixing device included in an image forming apparatus is known. For example, there is known an image forming apparatus that detects an abnormality, based on a surface temperature of at least one of a driving section and a driven section.

### SUMMARY OF THE INVENTION

In the conventional method, a relationship between the temperature of the driving section and the temperature of the driven section is not considered.

According to some aspects of the present disclosure, it is possible to provide an image forming apparatus, a control method thereof, and the like that accurately detect a slip state of a fixing belt.

An aspect of the present disclosure relates to an image forming apparatus including: a fixing belt; a pressure member that forms a nip portion with the fixing belt and drives the fixing belt; a heating member disposed inside the fixing belt; a fixing belt temperature detector that acquires fixing belt temperature information based on a temperature of the fixing belt; a pressure member temperature detector that acquires pressure member temperature information based on a temperature of the pressure member; and one or more controllers that determine whether or not the fixing belt is in a belt slip state where the fixing belt is not driven by movement of the pressure member, based on a relationship between the fixing belt temperature information and the pressure member temperature information.

Another aspect of the present disclosure relates to a control method of an image forming apparatus including a fixing belt, a pressure member that forms a nip portion with the fixing belt and drives the fixing belt, and a heating member disposed inside the fixing belt. The control method includes: acquiring fixing belt temperature information based on a temperature of the fixing belt; acquiring pressure member temperature information based on a temperature of the pressure member; and determining whether or not the fixing belt is in a belt slip state where the fixing belt is not driven by movement of the pressure member, based on a relationship between the fixing belt temperature information and the pressure member temperature information.

### BRIEF DESCRIPTION OF THE DRAWINGS

FIG. 1 is an appearance diagram of an image forming apparatus according to this embodiment.

FIG. 2 is a diagram illustrating a configuration example of the image forming apparatus.

FIG. 3 is a diagram illustrating a configuration example of an image former.

FIG. 4 is a cross-sectional view illustrating a schematic configuration of a fixing device in the image forming apparatus.

FIG. 5 is a perspective view illustrating a schematic configuration of the fixing device in the image forming apparatus.

FIG. 6A is a diagram illustrating an example of temperature changes of a fixing belt and a pressure roller in a normal state.

FIG. 6B is a diagram illustrating an example of temperature changes of the fixing belt and the pressure roller in a belt slip state.

FIG. 6C is a diagram illustrating an example of temperature changes of the fixing belt and the pressure roller in an other abnormal state.

FIG. 7 is a flowchart for describing a determination process of a belt slip state.

FIG. 8 is a flowchart for describing a determination process of the belt slip state.

FIG. 9 is a flowchart for describing an other determination process of the belt slip state.

FIG. 10 is a flowchart for describing an other determination process of the belt slip state.

FIG. 11 is a flowchart for describing an other determination process of the belt slip state.

### DETAILED DESCRIPTION OF THE INVENTION

The following describes an embodiment of the present disclosure with reference to accompanying drawings. In the drawings, the same or equivalent elements are assigned with the same reference numerals, and an overlapping description will be omitted. Note that the present embodiment to be described below does not unreasonably limit what is defined in the scope of claims. In addition, not all of the configurations described in the present embodiment are essential configuration requirements of the present disclosure.

### 1. System Configuration Example

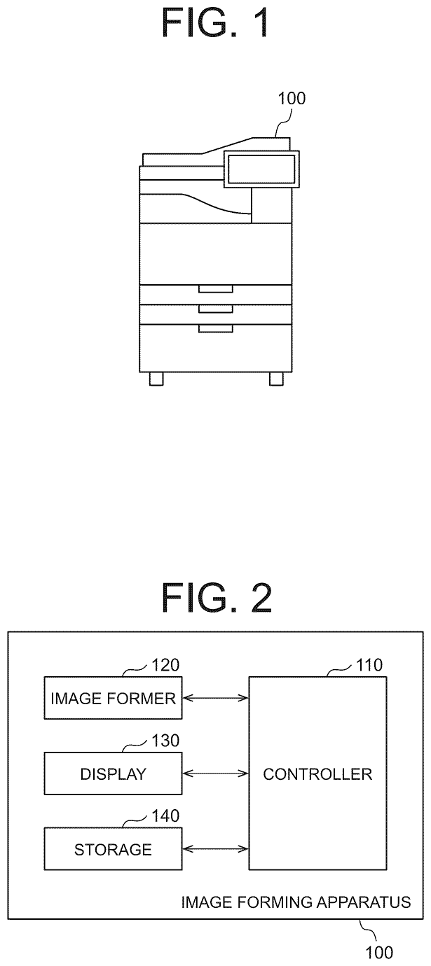

FIG. 1 is a diagram illustrating an example of appearance of an image forming apparatus 100. The image forming apparatus 100 according to the present embodiment is, for example, a color image forming apparatus that forms a multicolor or monochrome image on a sheet P such as a recording sheet in response to image data. Note that the image forming apparatus 100 may be a monochrome image forming apparatus. The image forming apparatus 100 may be a printer with a scanning function or a multifunction peripheral (MFP) having various functions including a printing function. The image forming apparatus 100 may have, for example, a copy function or a facsimile function.

FIG. 2 is a diagram illustrating a configuration example of the image forming apparatus 100. As illustrated in FIG. 2, the image forming apparatus 100 includes a controller 110, an image former 120, a display 130, and a storage 140. However, the configuration of the image forming apparatus 100 is not limited to the example illustrated in FIG. 2, and various modifications such as omitting a part of the configuration or adding an other configuration can be implemented. For example, the image forming apparatus 100 may further include a configuration, which is not illustrated in FIG. 2, such as an image reader that acquires image data by scanning a document.

The controller 110 is configured by the following hardware. The hardware may include at least one of a circuit that processes a digital signal and a circuit that processes an analog signal. For example, the hardware can be configured by one or a plurality of circuit devices mounted on a circuit board or one or a plurality of circuit elements. The one or plurality of circuit devices are, for example, an integrated circuit (IC), a field-programmable gate array (FPGA), or the like. The one or plurality of circuit elements are, for example, resistors, capacitors, and the like.

Further, the controller 110 may be achieved by one or more of the following processors. The image forming apparatus 100 according to the present embodiment includes a memory that stores information, and a processor that operates based on the information stored in the memory. The information is, for example, a program and various kinds of data. The processor includes hardware. As the processor, various processors such as a central processing unit (CPU), a graphics processing unit (GPU), and a digital signal processor (DSP) can be used. The memory may be a semiconductor memory such as a static random access memory (SRAM) or a dynamic random access memory (DRAM), may be a register, may be a magnetic storage device such as a hard disk drive (HDD), or may be an optical storage device such as an optical disk device. For example, the memory stores computer-readable instructions, and the processor executes the instruction, whereby the functions of the controller 110 are achieved as processing. The instruction here may be an instruction of an instruction set constituting a program, or may be an instruction for instructing a hardware circuit of a processor to perform an operation.

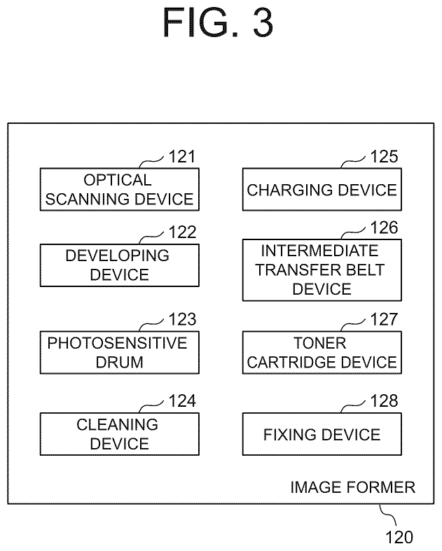

The image former 120 has a mechanical configuration for forming an image on the sheet P. The image forming apparatus 100 according to the present embodiment is, for example, a laser printer, and the image former 120 includes various configurations for executing printing using an electrophotographic system. Details of the image former will be described below with reference to FIGS. 3 to 5.

The display 130 is a display that displays an image. The display 130 can be achieved by, for example, a liquid crystal display or an organic EL display. The display 130 may be a user interface (UI) for using functions of the image forming apparatus 100, such as a print function and a scanning function.

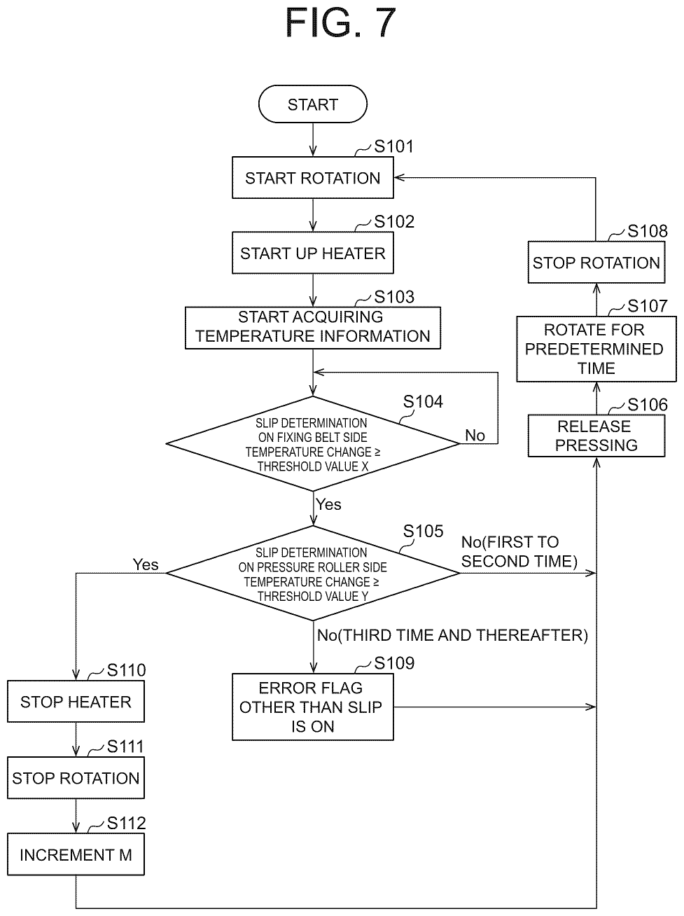

The storage 140 is a work area of the controller 110 and stores various kinds of information. The storage 140 may be achieved by various memories, and the memory may be a semiconductor memory, a register, a magnetic storage device, or an optical storage device. For example, the storage 140 may store an algorithm (program) for executing a determination process of the controller 110, parameters to be used in the algorithm, and the like. The algorithm here is, for example, an algorithm for executing a process to be described below with reference to FIG. 7 and the like, and the parameter may be, for example, a threshold value X or a threshold value Y illustrated in FIG. 7.

FIG. 3 is a diagram illustrating a configuration example of the image former 120. The image former 120 includes an optical scanning device 121, a developing device 122, a photosensitive drum 123 serving as an electrostatic latent image carrier, a cleaning device 124, a charging device 125, an intermediate transfer belt device 126, a toner cartridge device 127, and a fixing device 128. Further, the image forming apparatus 100 includes a sheet feeding tray and a discharge tray, which are not illustrated.

The charging device 125 charges the photosensitive drum 123. The optical scanning device 121 irradiates the charged photosensitive drum 123 with laser light, thereby weakening charge in an area corresponding to the image data. The developing device 122 causes a toner contained in the toner cartridge device 127 to adhere to a portion of the photosensitive drum 123 where the charge is relatively weak. The intermediate transfer belt device 126 transfers the toner adhered to the photosensitive drum 123 to the sheet P. The fixing device 128 fixes the toner adhered to the sheet P. The cleaning device 124 removes toner remaining on the surface of the photosensitive drum 123.

For example, when forming an image, the image forming apparatus 100 supplies a sheet P from a sheet feeding tray and conveys the sheet P by a first conveyance roller provided along a sheet conveyance path, which is not illustrated. Next, at a timing matched with a toner image on the intermediate transfer belt, the image forming apparatus 100 transfers the toner image onto the sheet P by conveying the sheet P by a transfer roller, which is not illustrated, in the sheet P and the intermediate transfer belt device 126. Thereafter, the image forming apparatus 100 causes the sheet P to pass through the fixing belt 10 and the pressure roller 20 of the fixing device 128, thereby melting and fixing the unfixed toner on the sheet P by heat, and discharges the sheet P onto the discharge tray via a second conveyance roller and a discharge roller, which are not illustrated.

The image data handled in the image forming apparatus 100 may correspond to a color image using a plurality of colors. The plurality of colors here are, for example, black (K), cyan (C), magenta (M), and yellow (Y) colors. Therefore, a plurality of the developing devices 122, the photosensitive drums 123, the cleaning devices 124, the charging devices 125, and the toner cartridge devices 127 are provided in such a way as to form a plurality of types of images corresponding to the respective colors, and these constitute a plurality of image stations.

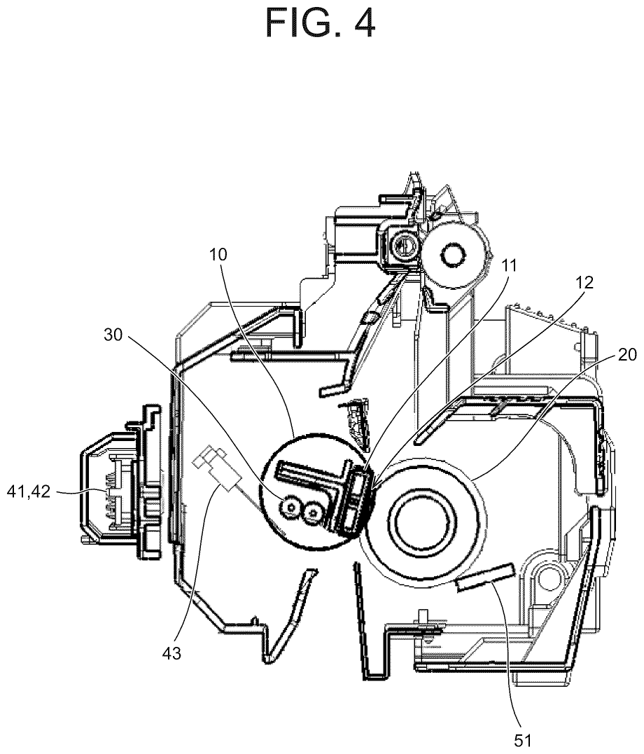

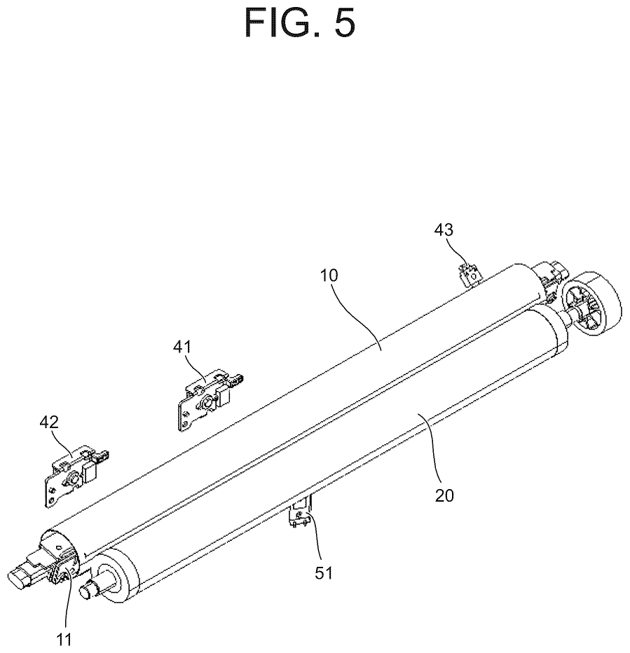

FIGS. 4 and 5 are diagrams each illustrating a configuration example of the fixing device 128. FIG. 4 is a cross-sectional view for describing a configuration of the fixing device 128, and FIG. 5 is a perspective view for describing the configuration of the fixing device 128. The fixing device 128 is, for example, a belt fixing-type fixing device. The fixing device 128 includes a fixing belt 10, a fixing pad 11, a pressure roller 20, a heater 30, a first thermopile 41, a second thermopile 42, a first thermistor 43, and a second thermistor 51.

The fixing belt 10 is rotatably provided around a rotation axis. The rotation axis here is an axis in a direction along a longitudinal direction of the fixing belt 10, and in a narrow sense, is an axis passing through the center of the cross-sectional shape (for example, a circular shape) of the fixing belt 10. The pressure roller 20 is provided in such a way as to be rotatable about a rotation axis, based on the driving of a driving section (for example, a driving motor) that is not illustrated. The rotation axis here is an axis in a direction along a longitudinal direction of the pressure roller 20, and in a narrow sense, is an axis passing through the center of the cross-sectional shape of the pressure roller 20.

A fixing pad 11 is disposed inside the fixing belt 10. The fixing device 128 is configured such that the pressure roller 20 is pressed against the fixing pad 11 via the fixing belt 10. When the pressure roller 20 is pressed against the fixing pad 11, a nip portion 12 is formed by the fixing belt 10 and the pressure roller 20. By providing the fixing pad 11, even when the fixing belt 10 and the pressure roller 20 are thin, a nip width (contact width) can be increased. The fixing device 128 may include a pressure contact unit that performs pressure contact, pressure adjustment, and pressure contact release of the pressure roller 20 against the fixing belt 10, and that is not to be illustrated. In a state where the nip portion 12 is formed, the fixing belt 10 is driven to rotate by the pressure roller 20 rotating in accordance with the driving of the driving section.

The heater 30 is disposed inside the fixing belt 10, and heat of the heater 30 is transmitted to the fixing belt 10. When the fixing belt 10 is close to the pressure roller 20 (in a narrow sense, in contact with the pressure roller 20, and more specifically, driven by the pressure roller 20), the heat of the fixing belt 10 is transmitted to the pressure roller 20. The fixing belt 10 thermally presses multicolor toner image transferred onto the sheet P against the sheet P together with the pressure roller 20. As a result, the multicolor toner image is melted, mixed, and press-contacted to be thermally fixed on the sheet P.

The first thermopile 41, the second thermopile 42, and the first thermistor 43 are sensors that detect fixing belt temperature information based on the temperature of the fixing belt 10. Since specific configurations of the thermopile and the thermistor are known, detailed description thereof will be omitted. The first thermopile 41 is a sensor that detects a temperature in the vicinity of the center of the sheet P when the sheet P is conveyed. The second thermopile 42 is a sensor that detects a temperature in the vicinity of an end portion of the sheet P when the sheet P is conveyed. The first thermistor 43 is a sensor that detects a temperature at a position (in the vicinity of an end portion of the fixing belt 10) that does not overlap the sheet P when the sheet P is conveyed. The first thermistor 43 is, for example, a contact-type thermistor disposed at a position in contact with the fixing belt 10. Note that it is not essential to provide all of the first thermopile 41, the second thermopile 42, and the first thermistor 43, and some of them may be omitted. Further, the configuration and arrangement of the sensor for detecting fixing belt temperature information are not limited to the examples of FIGS. 4 and 5, and various modifications can be performed.

The second thermistor 51 is a sensor that detects pressure member temperature information, based on a temperature of the pressure roller 20. The second thermistor 51 is a sensor that detects the temperature in the vicinity of the center of the sheet P when the sheet P is conveyed. For example, the second thermistor 51 may be disposed at a position where the fixing belt 10 and the pressure roller 20 are opposed, in the rotation axis direction (a position where a positional deviation in the rotation axis direction is equal to or less than a predetermined value). The second thermistor 51 is, for example, a non-contact thermistor disposed at a position not in contact with the pressure roller 20. The configuration and arrangement of the sensor for detecting the pressure member temperature information are not limited to the examples illustrated in FIGS. 4 and 5, and various modifications can be performed.

As described above, the image forming apparatus 100 according to the present embodiment includes the fixing belt 10, the pressure member, the heating member, the fixing belt temperature detector, the pressure member temperature detector, and the controller 110. The pressure member here is a member that forms the nip portion 12 with the fixing belt 10 and drives the fixing belt 10, and corresponds to, for example, the pressure roller 20. The heating member is a member that is disposed near (in a narrow sense, inside) the fixing belt 10 and that supplies heat to the fixing belt 10, and corresponds to, for example, the heater 30. The fixing belt temperature detector is a sensor that acquires fixing belt temperature information based on the temperature of the fixing belt 10, and includes, for example, one or more of the first thermopile 41, the second thermopile 42, and the first thermistor 43. The pressure member temperature detector is a sensor that acquires pressure member temperature information based on the temperature of the pressure member, and corresponds to, for example, the second thermistor 51 that detects information based on the temperature of the pressure roller 20.

The controller 110 in the present embodiment determines whether or not the fixing belt is in a belt slip state, based on a relationship between the fixing belt temperature information and the pressure member temperature information. Note that the belt slip state here represents a state where the fixing belt 10 is not appropriately moved (rotated) with respect to movement (rotation) of the pressure roller 20. The belt slip state is not limited to a state in which the fixing belt 10 does not move at all, but includes a state in which an actual movement amount of the fixing belt 10 is smaller than an assumed movement amount of the fixing belt 10, which is assumed based on the movement amount of the pressure roller 20. For example, the belt slip state in the present embodiment may represent a state in which, when a difference between an assumed movement amount and an actual movement amount is set as a deviation amount, the deviation amount is equal to or larger than a predetermined threshold value. Further, when a ratio of the deviation amount to the assumed movement amount is set as a slip index value, a state in which the slip index value is equal to or larger than a predetermined threshold value may be set as the belt slip state. Furthermore, the belt slip state here is a state where the fixing belt 10 is not rotated more than assumed, but is not limited thereto, and may include a state where the fixing belt 10 is excessively rotated more than assumed. In other words, the above-described deviation amount is not limited to a value acquired by subtracting the actual movement amount from the assumed movement amount, and may include a value acquired by subtracting the assumed movement amount from the actual movement amount.

According to the method of the present embodiment, the belt slip state is determined using the relationship between the temperature of the fixing belt 10 and the temperature of the pressure roller 20 that presses the fixing belt 10. Therefore, it becomes possible to accurately determine the belt slip state.

For example, when the heater 30 is provided inside the fixing belt 10, heat of the heater 30 is transmitted to the pressure roller 20 via the fixing belt 10. At this time, in the belt slip state, a heat transfer state from the fixing belt 10 to the pressure roller 20 is different from that in a normal state (a state in which a belt slip does not occur), and therefore, it is considered that the temperature of the pressure roller 20 also exhibits a behavior different from that in the normal state. Specifically, it is assumed that the temperature of the pressure roller 20 follows the temperature of the fixing belt 10 to a high degree in the normal state, but the temperature of the pressure roller 20 follows the temperature of the fixing belt 10 to a low degree in the belt slip state. For that reason, by using the relationship between the fixing belt temperature information and the pressure member temperature information, it is possible to increase accuracy of determining the belt slip state.

Further, in a case where an abnormality other than the belt slip, such as excessive heat generation of the heater 30, occurs, when the fixing belt temperature information alone or the pressure member temperature information alone is observed, it is considered that the temperature behaves differently from the normal state. Therefore, there is a possibility that it is not easy to separate between the belt slip state and other abnormalities by the determination using only one of the pieces of the temperature information or the determination using the two pieces of temperature information independently. In this regard, in the present embodiment, the relationship between the fixing belt temperature information and the pressure member temperature information (for example, a degree of following) is determined. If the belt is not in the belt slip state, it is assumed that the degree of following is high even when an other abnormality occurs. Therefore, in the method of the present embodiment, it is possible to appropriately separate the belt slip state from the other abnormality.

As described above, in the method of the present embodiment, the accuracy of the determination of the belt slip state can be increased, and therefore, it is possible to suppress the fixing belt 10 from being damaged due to the heat concentration on a part of the fixing belt 10. Further, the method of the present embodiment can be applied to a control method of the image forming apparatus 100 including the fixing belt 10, a pressure member that forms the nip portion 12 with the fixing belt 10 and drives the fixing belt 10, and a heating member disposed inside the fixing belt 10. The control method includes a step of acquiring fixing belt temperature information based on the temperature of the fixing belt 10, a step of acquiring pressure member temperature information based on the temperature of the pressure member, and a step of determining whether or not the fixing belt 10 is in a belt slip state where the fixing belt 10 is not driven by movement of the pressure member, based on the relationship between the fixing belt temperature information and the pressure member temperature information.

### 2. Details of Process

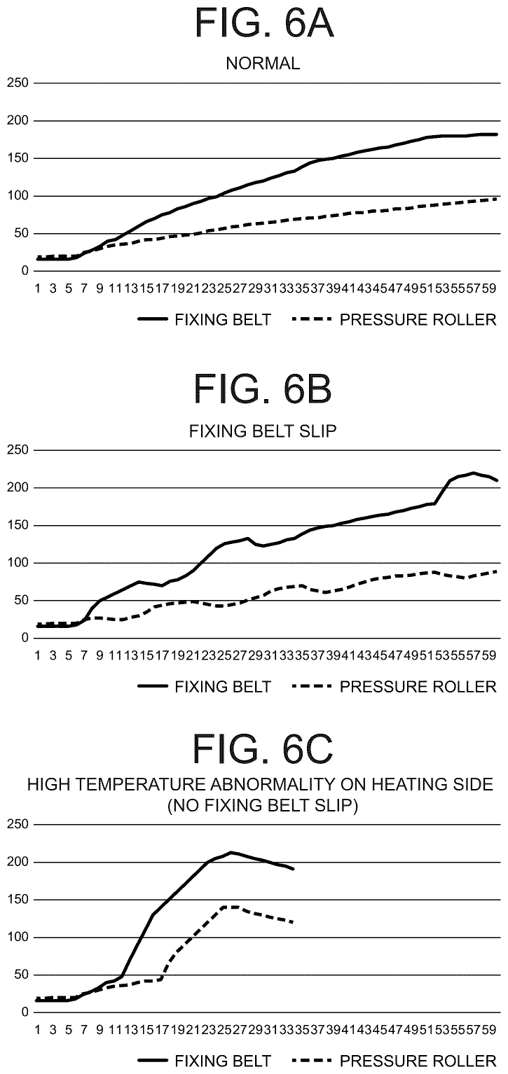

FIGS. 6A to 6C are diagrams each illustrating an example of changes in the fixing belt temperature information and the pressure member temperature information after the start of heating by the heater 30. In FIGS. 6A to 6C, each horizontal axis represents time and each vertical axis represents temperature.

FIG. 6A is a diagram illustrating an example of temperature change in a normal state where no abnormality occurs. As illustrated in FIG. 6A, in a normal state, heat generated by the heater 30 is uniformly transmitted to the fixing belt 10 to some extent. Therefore, the temperature of the fixing belt detected by the fixing belt temperature detector increases with time by a change amount close to a certain inclination, and becomes substantially constant at a desired temperature. In addition, in the normal state, no belt slip also occurs, and therefore, no heat concentration occurs on the fixing belt 10, and the fixing belt 10 and the pressure roller 20 rotate at the same speed. Therefore, as the temperature of the fixing belt 10 rises, the temperature of the pressure roller 20 represented by the pressure member temperature information also increases by a change amount close to a certain inclination. As illustrated in FIG. 6A, the pressure roller 20 is relatively far from the heater 30, and therefore, an inclination of the temperature change of the pressure roller 20 may be smaller than that of the fixing belt 10.

FIG. 6B is a diagram illustrating an example of temperature change in a belt slip state. When the belt slip state occurs, a period in which the fixing belt 10 does not move as much as assumed occurs. Therefore, it is considered that heat is concentrated on a part of the fixing belt 10. For that reason, the temperature detected by the fixing belt temperature detector such as the first thermistor 43 does not change with a nearly constant inclination, and there is a period in which the inclination is relatively large or a period in which the inclination is relatively small.

Further, the temperature of the pressure roller 20 detected by the pressure member temperature detector such as the second thermistor 51 does not change with a nearly constant inclination, and there is a period in which the inclination is relatively large or a period in which the inclination is relatively small. For example, in a state in which the fixing belt 10 is not rotated at all with respect to the pressure roller 20, since the same position of the fixing belt 10 is kept in contact with the pressure roller 20, there is a possibility that the heat conducted from the fixing belt 10 to the pressure roller 20 becomes smaller than that in the normal state. Specifically, as illustrated in FIG. 6B, in the belt slip state, since heat conduction is not appropriately performed, there occurs a period in which the temperature change of the fixing belt 10 is larger than that in the normal state and the temperature change of the pressure roller 20 is smaller than that in the normal state.

FIG. 6C is a diagram illustrating an example of temperature change when an abnormality other than the belt slip state occurs. FIG. 6C is a diagram illustrating a temperature change when a heater abnormality occurs, for example, when the heater 30 becomes higher in temperature than in a normal state. As illustrated in FIG. 6C, in the state where the heater abnormality occurs, an amount of heat that is transferred from the heater 30 to the fixing belt 10 is larger than that in the normal state, and thus the temperature of the fixing belt detected by the fixing belt temperature detector increases with the lapse of time at a larger inclination than that in the normal state.

Further, even when the heater abnormality occurs, the fixing belt 10 and the pressure roller 20 are rotated in a constant relationship unless the fixing belt is in the belt slip state. Therefore, although the amount of heat transferred from the fixing belt 10 to the pressure roller 20 is larger than that in the normal state, the amount of heat does not largely change at each timing. Therefore, the temperature of the pressure roller 20 detected by the pressure member temperature detector such as the second thermistor 51 changes with the lapse of time at a larger inclination than in the normal state.

As can be seen from FIGS. 6A to 6C, in the belt slip state, the fixing belt 10 and the pressure roller 20 are not driven, and thus a degree of following to which the pressure member temperature information follows the fixing belt temperature information is low (FIG. 6B). Herein, the low degree of following may indicate that a degree of matching between a change tendency of the fixing belt temperature information and a change tendency of the pressure member temperature information is low. On the other hand, in both of the normal state and the abnormal state, the degree of following to which the pressure member temperature information follows the fixing belt temperature information becomes high unless the fixing belt is in the belt slip state (FIGS. 6A and 6C).

Therefore, by the method of the present embodiment, the controller 110 may determine the degree of following to which the pressure member temperature information follows the fixing belt temperature information, and may determine that the belt is in the belt slip state in a case where the degree of following is determined to be equal to or less than a given threshold value. In this way, it is possible to accurately determine whether or not the belt is in the belt slip state.

For example, the controller 110 may determine whether or not the fixing belt 10 is in the belt slip state, based on a change in the fixing belt temperature information per unit time and a change in the pressure member temperature information per unit time. As illustrated in FIG. 6B, in the belt slip state, both a timing at which the temperature of the fixing belt 10 rapidly changes and a timing at which the temperature of the pressure roller 20 rapidly changes occur as compared with the normal state. Therefore, by using both the change in the fixing belt temperature information per unit time and the change in the pressure member temperature information per unit time, it is possible to accurately determine whether or not the fixing belt is in the belt slip state.

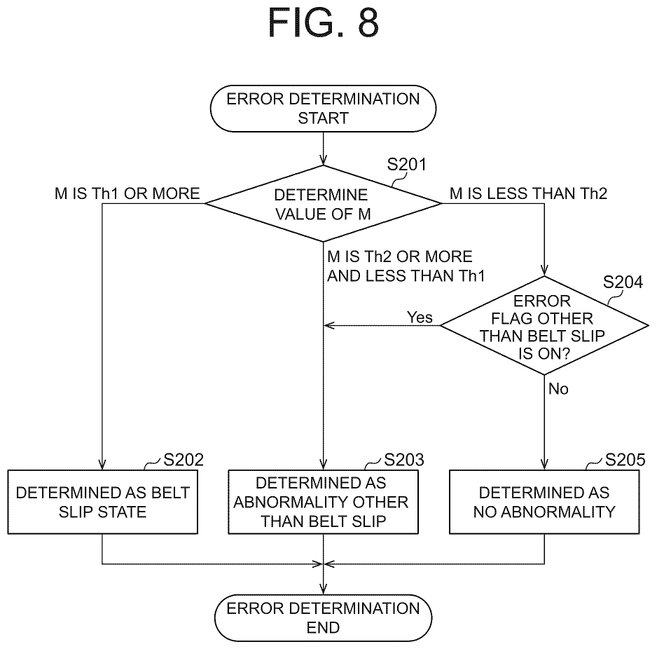

Further, when it is determined that the degree of following to which the pressure member temperature information follows the fixing belt temperature information is larger than a given threshold value, the controller 110 may determine that an abnormality other than the belt slip state has occurred or no abnormality has occurred. In this way, it is possible to appropriately separate between the belt slip state and other states. Hereinafter, an example of a specific process will be described with reference to FIGS. 7 and 8. FIGS. 7 and 8 are flowcharts for describing a determination process regarding the belt slip state. FIG. 7 is a diagram for describing a process to be executed when heating by the heater 30 is started. For example, the controller 110 repeatedly executes the process illustrated in FIG. 7 for a predetermined time or a predetermined number of loops at a time of start-up of the image forming apparatus 100 or at a time of return from a sleep state. The controller 110 may determine whether or not the belt is in the belt slip state by executing the process illustrated in FIG. 8 after the process illustrated in FIG. 7 is finished. Details will be described below.

When the process illustrated in FIG. 7 is started, first, in step S101, the pressure roller 20 starts to rotate while being pressed against the fixing belt 10. In step S102, the heater 30 is started up. In step S103, the fixing belt temperature detector starts detection of fixing belt temperature information based on the temperature of the fixing belt 10, and the pressure member temperature detector starts detection of pressure member temperature information based on the temperature of the pressure member (pressure roller 20).

In step S104, the controller 110 executes the slip determination on the fixing belt 10 side by using the fixing belt temperature information. Specifically, the controller 110 acquires a change in the fixing belt temperature information per unit time. The change per unit time here may be given by the following expression (1), where U(t) is a value of the fixing belt temperature information acquired at a certain timing t, U(t+1) is a value of the fixing belt temperature information acquired at a next timing t+1, and Δt is a time difference between the timing t and the timing t+1. However, the amount of change per unit time is not limited to this, and may be acquired based on the temperature and the time difference at two timings that are not adjacent to each other, or may be acquired based on three or more timings.

### Change in Fixing Belt Temperature Information Per Unit Time

$$= \{ U ( t + 1 ) - U ( t ) \} / Δ t \qquad ( 1 )$$

The controller 110 compares the change in the fixing belt temperature information per unit time with a given change amount threshold value X. The change amount threshold value X is a threshold value for determining whether a degree of dissociation from a change amount x in the normal state (for example, an inclination of the temperature graph of the fixing belt 10 in FIG. 6A) is large, and may be, for example, X=x+Δx (wherein Δx is a positive number set in advance).

When the change in the fixing belt temperature information per unit time is less than the change amount threshold value X (step S104: No), it is considered that no abnormality has occurred. Therefore, the controller 110 returns to step S104 and continues the process. In other words, when no abnormality is found in the fixing belt temperature information, the determination process of step S104 is repeatedly executed.

When the change in the fixing belt temperature information per unit time is equal to or greater than the change amount threshold value X (step S104: Yes), in step S105, the controller 110 executes the slip discrimination on the pressure roller 20 side by using the pressure member temperature information. Specifically, the controller 110 acquires a change in the pressure member temperature information per unit time. The change per unit time here may be given by a following expression (2), where V(t) is a value of the pressure member temperature information acquired at a certain timing t, V(t+1) is a value of the pressure member temperature information acquired at a next timing t+1, and Δt is a time difference between the timing t and the timing t+1.

### Change in Pressure Member Temperature Information Per Unit Time

$$= \{ V ( t + 1 ) - V ( t ) \} / Δ t \qquad ( 2 )$$

The controller 110 compares the change in the pressure member temperature information per unit time with a given change amount threshold value Y The change amount threshold value Y here is a threshold value for determining whether the degree of dissociation from a change amount y in the normal state (for example, the inclination of the temperature graph of the pressure roller 20 in FIG. 6A) is large, and may be, for example, Y=y+Δy (Δy is a positive number set in advance). For example, the change amount threshold value Y is a value smaller than the change amount threshold value X. However, the same value as the change amount threshold value X may be used as the change amount threshold value Y.

Note that t in step S104 and t in step S105 may be the same timing or may be different timings. For example, when it is determined that the change in the fixing belt temperature information per unit time is equal to or greater than the change amount threshold value X (step S104: Yes), the controller 110 may set a determination period of a given duration, repeatedly acquire an amount of change in the pressure member temperature information per unit time in the determination period, and execute the process of comparing with the change amount threshold value Y For example, the controller 110 may set a determination result in step S105 to “Yes” when the amount of change in the pressure member temperature information per unit time is equal to or greater than the change amount threshold value Y at least once in the determination period. This makes it possible to make an appropriate determination even when the fixing belt 10 and the pressure roller 20 rapidly rise in temperature at different timings, as illustrated in FIG. 6B.

When the change in the pressure member temperature information per unit time is less than the change amount threshold value Y (step S105: No), the temperature change of the pressure roller 20 is small and is different from the characteristic of the temperature change illustrated in FIG. 6B, and thus the possibility of the belt slip state is low. However, the temperature of the fixing belt 10 rapidly changes (step S104: Yes), which is different from the characteristic of the temperature change illustrated in FIG. 6A, and thus an abnormality is suspected. Therefore, the controller 110 determines whether the situation is improved by performing a retry operation.

For example, the controller 110 counts the number of times that an abnormality is detected on the fixing belt 10 side and no abnormality is detected on the pressure roller 20 side (step S104: Yes and step S105: No), and when the number of times is the first time and the second time, the controller 101 executes the retry operation of steps S106 to S108.

To be more specific, in step S106, the controller 110 releases the pressure to fixing belt 10 (fixing pad 11) by the pressure roller 20. In step S107, the controller 110 rotates the pressure roller 20 for a predetermined time in a state where the pressure roller 20 applies no pressure to the fixing belt 10. In step S108, the controller 110 stops the rotation of the pressure roller 20 and returns to step S101. In the retry operation in this case, the start-up state of the heater 30 may be maintained, and the process of step S102 after returning to step S101 may be omitted.

In addition, in a case where the number of times when an abnormality is detected on the fixing belt 10 side and no abnormality is on the pressure roller 20 side is the third time or thereafter, the controller 110 sets an error flag indicating that an error other than the belt slip state occurs in step S109 to ON and then executes the retry operation of steps S106 to S108.

Further, when an abnormality is detected on the fixing belt 10 side and an abnormality is also detected on the pressure roller 20 side (step S104: Yes and step S105: Yes), it is suspected that the fixing belt is in the belt slip state. Therefore, the controller 110 executes the retry operation after stopping the heater 30.

To be specific, in step S110, the controller 110 turns off the heater 30. In step S111, the controller 110 stops the rotation of the pressure roller 20. Further, in step S112, the controller 110 counts up a variable M representing the number of times an abnormality is detected on the fixing belt 10 side and an abnormality is also detected on the pressure roller 20 side (step S104: Yes and step S105: Yes). For example, M is a variable that is initialized to 0 when the process illustrated in FIG. 7 is started. After the process in step S111, the controller 110 executes the retry operation of steps S106 to S108, returns to step S101, and continues the process.

After the process illustrated in FIG. 7 is executed for a certain time or a certain number of loops, the controller 110 executes an abnormality determination process illustrated in FIG. 8. First, in step S201, the controller 110 determines whether the variable M is equal to or greater than a first number-of-times threshold value Th1. The first number-of-times threshold value Th1 here is, for example, 4, but may be set to an other value.

When the variable M is equal to or greater than the first number-of-times threshold value Th1, the controller 110 determines that the belt is in the belt slip state in step S202. In other words, the controller 110 determines that the fixing belt is in the belt slip state when a state in which the amount of change in the fixing belt temperature information per unit time is equal to or greater than the first change amount threshold value (change amount threshold value X) and the amount of change in the pressure member temperature information per unit time is equal to or greater than a second change amount threshold value (change amount threshold value Y) is detected a predetermined number of times or more (when M is equal to or greater than the first number-of-times threshold value Th1).

As described above with reference to FIG. 6B, in the belt slip state, a rapid change in the temperature of the fixing belt 10 and a rapid change in the temperature of the pressure roller 20 repeatedly occur. Therefore, as illustrated in steps S201 and S202, it is possible to accurately detect the belt slip state by determining the amount of change per unit time and the threshold value for each of the fixing belt temperature information and the pressure member temperature information.

In step S201, the controller 110 determines whether the variable M is equal to or greater than a second number-of-times threshold value Th2 and less than the first number-of-times threshold value Th1. The second number-of-times threshold value Th2 here is smaller than the first number-of-times threshold value Th1. The second number-of-times threshold value Th2 is, for example, 3, but may be set to an other value.

When the variable M is equal to or greater than the second number-of-times threshold value Th2 and less than the first number-of-times threshold value Th1, the controller 110 determines in step S203 that an abnormality is other than the belt slip state. In this case, although there is a history that the temperatures of both the fixing belt 10 and the pressure roller 20 have rapidly changed, the number of times of occurrence thereof is not equal to or greater than the first number-of-times threshold value Th1, and thus the changes are not continuously detected. In short, since the abnormality here has a characteristic different from that of the belt slip state, it is possible to appropriately separate contents of the abnormality by determining that the abnormality is other than the belt slip state.

For example, in the heater abnormality illustrated in FIG. 6C, since there is a period in which the temperature rapidly rises, it may be determined that the change in the fixing belt temperature information per unit time is equal to or greater than the change amount threshold value X and the amount of change in the pressure member temperature information per unit time is equal to or greater than the change amount threshold value Y in the period. However, in the heater abnormality illustrated in FIG. 6C, since the period in which the temperature rapidly rises is relatively short compared to the duration of the belt slip state, the number of times M is incremented is also small. Therefore, as illustrated in steps S201 to S203, by determining the value of M, it is possible to separate the contents of the abnormality.

When the variable M is less than the second number-of-times threshold value Th2, the controller 110 determines an error flag indicating an abnormality other than the belt slip state in step S204. When the error flag is ON (step S204: Yes), the controller 110 determines in step S203 that an abnormality is other than the belt slip state. This corresponds to the case where the process of step S109 is executed in the process of FIG. 7. In other words, the error flag being ON corresponds to a case where the number of times of abnormality detection on the pressure roller 20 side is small, but the number of times of abnormality detection on the fixing belt 10 side is equal to or greater than a predetermined value, and therefore, there is a high probability that an abnormality other than the belt slip state has occurred.

As an abnormality other than the belt slip state, a sensor abnormality, which is an abnormality in the fixing belt temperature detector, is considered. When the sensor abnormality occurs, for example, even though the temperature of the fixing belt 10 is actually in a normal state (FIG. 6A), the value of the fixing belt temperature information, which is a detection result, may rapidly change. In this example, heat concentration does not occur in the actual fixing belt 10, and the belt slip state does not occur, and thus heat transfer to the pressure roller 20 is also smoothly executed. Therefore, if there is no abnormality in the pressure member temperature detector, the pressure member temperature information exhibits a behavior close to the normal state (FIG. 6A).

Therefore, the controller 110 may determine that an abnormality other than the belt slip state has occurred when it is determined that the amount of change in the fixing belt temperature information per unit time is equal to or greater than the first change amount threshold value (change amount threshold value X) and it is determined that the amount of change in the pressure member temperature information per unit time is less than the second change amount threshold value (change amount threshold value Y). As a result, it is possible to appropriately separate the abnormality contents.

On the other hand, when the error flag is OFF (step S204: No), the controller 110 determines that the state is a normal state in step S205. This corresponds to a case where no temperature abnormality of the fixing belt 10 is not detected in the first place in the process of FIG. 7, or a case where a temperature abnormality of the fixing belt 10 is detected but the number of times thereof is small. This corresponds to, for example, a case where a sudden abnormality occurs but the abnormality is eliminated by the retry operation (steps S106 to S108), a case where no fundamental abnormality occurs in the first place and a rapid temperature change is detected due to noise, or the like.

Although not illustrated in FIGS. 7 and 8, when determining that the fixing belt 10 is in the belt slip state, the controller 110 may perform control to stop heating by the heating member (heater 30) and control to stop rotation of the fixing belt 10. The control to stop the rotation of the fixing belt 10 may be control to stop the rotation of the pressure roller 20. In this way, it is possible to prevent the belt slip state from continuing.

Further, in a case where the belt slip state is suspected, the controller 110 may perform control to stop heating by the heating member (heater 30) and control to stop the rotation of the fixing belt 10. For example, the case where the belt slip state is suspected is a case where there is an abnormality in temperature on both the fixing belt 10 side and the pressure roller 20 side (steps S104 and S105: Yes), and the control to stop the heating by the heating member and the control to stop the rotation of the fixing belt 10 may be the retry operation of steps S106 and S107. In this way, even in a state where the belt slip state is not confirmed, it is possible to attempt to eliminate the abnormality by the retry operation.

Although a specific example of the determination process of the belt slip state has been described above, the process of the present embodiment is not limited to those illustrated in FIGS. 7 and 8. For example, the process in FIG. 7 may end when a given condition is satisfied. For example, in a case where the number of times of determination as No is made in step S104 is equal to or greater than a predetermined number, the controller 110 may determine that the state is the normal state and end the process illustrated in FIG. 7. In addition, the controller 110 may determine that the state is an abnormality state other than the belt slip state and end the process illustrated in FIG. 7 in a case where the number of times determination as No is made in step S105 is three times. In other words, in a case where the normal state of the fixing belt 10 is detected a certain number of times or more, or in a case where the normal state of the pressure roller 20 is detected a certain number of times or more, the probability that the fixing belt is not in the belt slip state is high, and therefore at that stage, determination that the fixing belt is in a state other than the belt slip state can be confirmed.

### 3. Modified Example

Hereinafter, some modified examples will be described.

### 3.1 Other Example of Slip Determination

In the example described above with reference to FIG. 7, as the slip determination using the fixing belt temperature information (step S104) and the slip determination using the pressure member temperature information (step S105), the process of comparing the change amount per unit time with the change amount threshold value as indicated by the above expressions (1) and (2) has been described. The change amount threshold values X and Y here are, for example, positive values, and the above-described slip determination may be a determination as to whether or not the temperature has rapidly risen as compared to the usual state. However, the slip determination is not limited thereto.

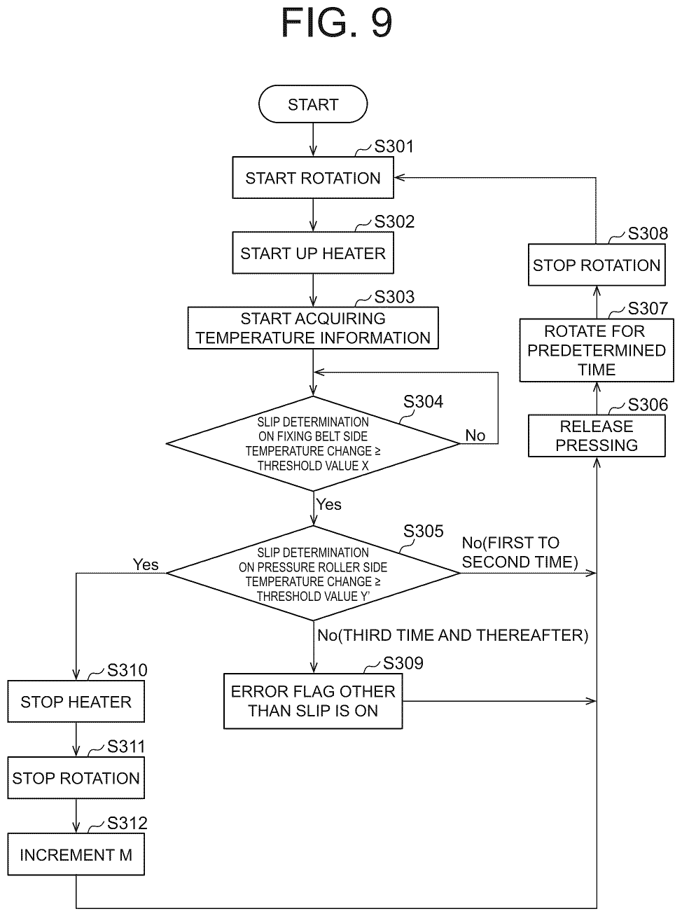

FIG. 9 is a diagram for describing an other determination process regarding the belt slip state. Steps S301 to S303 and S306 to S312 in FIG. 9 are the same as steps S101 to S103 and S106 to S112 in FIG. 7. Therefore, description of overlapping parts will be omitted.

For example, as illustrated in FIG. 6B, when the belt slip occurs, the heat transfer from the fixing belt 10 to the pressure roller 20 is prevented, and thus the inclination of the graph of the fixing belt temperature information becomes large and the inclination of the graph of the pressure member temperature information becomes small in some cases. Therefore, the controller 110 may perform slip determination as to whether a temperature change amount of the fixing belt 10 per unit time is equal to or greater than the threshold value, in step S304, and may perform slip determination as to whether a temperature change amount of the pressure roller 20 per unit time is equal to or less than the threshold value, in step S305.

For example, as a change amount threshold value Y′, a value set by Y′=y−Δy′ (Δy′ is a positive number set in advance), based on the change amount y in the normal state (for example, the inclination of the graph in FIG. 6A) may be used. Then, in step S305, when the amount of change in the pressure member temperature information per unit time is equal to or less than the change amount threshold value Y′, the controller 110 determines that there is a possibility of slipping (step S305: Yes). As illustrated in FIG. 6B, it is considered that the timing at which the inclination of the graph of the fixing belt temperature information becomes large and the timing at which the inclination of the graph of the pressure member temperature information becomes small are sufficiently close to each other. Therefore, it is desirable that t and t+1, which are used when acquiring the amount of change per unit time, are set to be common or sufficiently close values in steps S304 and S305.

As described above, the belt slip state can be accurately determined by determining whether the pressure roller 20 behaves differently (changes in the direction in which the inclination decreases) with respect to the temperature change of the fixing belt 10. For example, since the temperature change of the pressure roller 20 follows the temperature change of the fixing belt 10 in the normal state illustrated in FIG. 6A or the heater abnormality illustrated in FIG. 6C, there is a sufficiently low possibility that the two temperatures change in opposite directions at close timings. Therefore, it is possible to appropriately separate the belt slip state, the normal state, and the abnormal state other than the belt slip state.

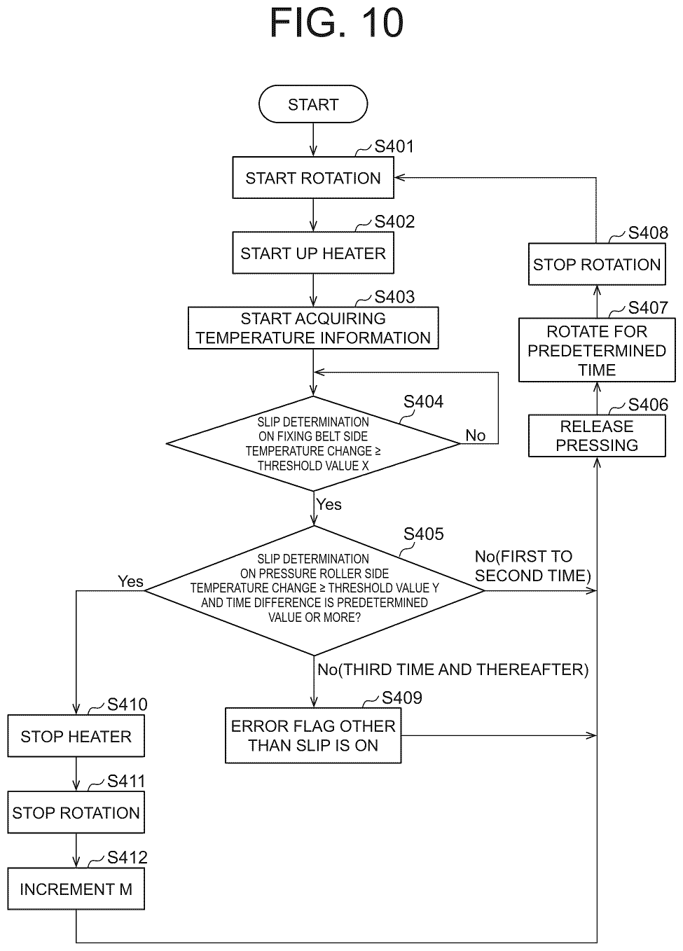

FIG. 10 is a diagram for describing still another determination process related to the belt slip state. Steps S401 to S403 and S406 to S412 in FIG. 10 are the same as the steps S101 to S103 and S106 to S112 in FIG. 7. Therefore, description of overlapping parts will be omitted. As illustrated in FIG. 6B, in the belt slip state, the degree of following is low, and thus the timing at which the temperature rapidly rises is greatly different between the fixing belt 10 and the pressure roller 20, whereas as illustrated in FIG. 6C, in the other abnormality, the degree of following is high, and thus the timing at which the temperature rapidly rises (decreases) is close between the fixing belt 10 and the pressure roller 20.

Therefore, the controller 110 may detect rapid changes in the fixing belt temperature information and the pressure member temperature information in steps S404 and S405, and may further perform a process of acquiring a time difference between detection timings in step S405. In a case where the detection timing difference between the rapid changes is equal to or greater than a predetermined threshold value, the controller 110 determines that the belt slip state is suspected, and shifts to the process of step S410. On the other hand, in a case where the pressure member temperature information does not rapidly change in the first place, or in a case where the pressure member temperature information rapidly changes but the timing difference is less than the predetermined threshold value, an abnormality other than the belt slip state is suspected. Therefore, the controller 110 determines No in step S405, and shifts to the process of step S406 or step S409 according to the number of times. By determining the timing difference in this way, it is possible to appropriately separate the abnormality contents.

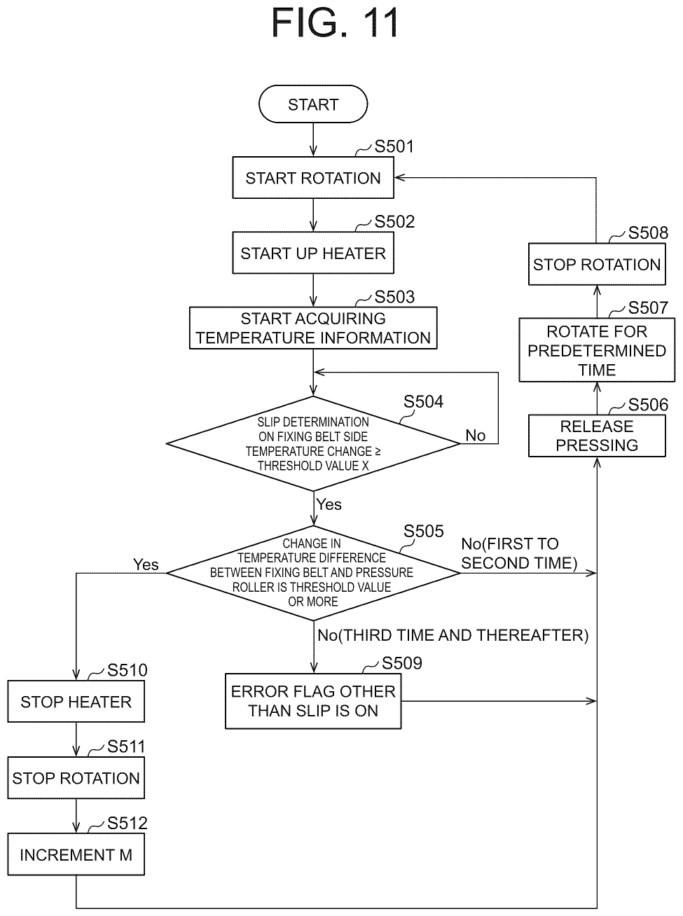

FIG. 11 is a diagram for describing still another determination process regarding the belt slip state. Steps S501 to S503 and S506 to S512 in FIG. 11 are the same as steps S101 to S103 and S106 to S112 in FIG. 7. Therefore, description of overlapping parts will be omitted.

As illustrated in FIG. 6B, in the belt slip state, the timing at which the temperature rapidly changes greatly differs between the fixing belt 10 and the pressure roller 20, and thus the difference between the temperature of the fixing belt 10 and the temperature of the pressure roller 20 repeatedly increases and decreases. On the other hand, as illustrated in FIG. 6C, since the degree of following is high in other abnormalities, the timing at which the temperature rapidly changes is close between the fixing belt 10 and the pressure roller 20, and the change in temperature difference is relatively small.

Therefore, the controller 110 may determine whether or not the belt is in the belt slip state, based on thermal gradient represented by the difference between the fixing belt temperature information and the pressure member temperature information. In this way, it is possible to appropriately separate the normal state, the belt slip state, and the abnormal state other than the belt slip state.

For example, the controller 110 may determine whether or not the belt is in the belt slip state, based on a temporal change in the thermal gradient. To be specific, in step S505, the controller 110 acquires a difference W between the fixing belt temperature information and the pressure member temperature information and a temporal change ΔW of the difference by the following expressions (3) and (4). U, V, t, and Δt are the same as in the above expressions (1) and (2).

$$W ( t ) = U ( t ) - V ( t ) \qquad ( 3 )$$

$$Δ W = \{ W ( t + 1 ) - W ( t ) \} / Δ t \qquad ( 4 )$$

Then, in the determination in step S505, when the value of ΔW is equal to or greater than a given threshold value, the controller 110 determines that the belt slip state is suspected, and shifts to the process in step S510. In addition, when the value of ΔW is less than a given threshold value, the controller 110 determines that an abnormality other than the belt slip state is suspected, and shifts to the process of step S506 or step S509 according to the number of times. By determining the thermal gradient in this way, it is possible to appropriately separate the abnormality contents.

Some examples of the determination process of the belt slip state have been described above, but the process of the present embodiment is not limited thereto, and various processes of determining the degree of following to which the pressure member temperature information follows the fixing belt temperature information can be applied. For example, the controller 110 may acquire a similarity between a waveform representing a temporal change in the fixing belt temperature information and a waveform representing a temporal change in the pressure member temperature information, and determine that the belt is in the belt slip state when the similarity is equal to or less than a predetermined threshold value. Note that various methods of acquiring the similarity of waveforms are known, and these methods can be widely applied to this embodiment. In addition, as illustrated in FIG. 6A, since it is assumed that the temperature of the fixing belt 10 is higher than the temperature of the pressure roller 20, a normalizing process (for example, a process of matching the average values) may be performed as a pre-process when the similarity of the waveforms is acquired.

### 3.2 Drive of Fixing Belt

Further, in the above description, the example in which the image forming apparatus 100 does not include the driving section that directly drives the fixing belt 10, and the fixing belt 10 is driven by the rotation of the pressure member is given. However, the image forming apparatus 100 according to the present embodiment is not limited thereto, and may include a plurality of driving sections capable of independently driving the pressure member and the fixing belt 10. The plurality of driving sections fix a toner to a sheet P by rotating the pressure member and the fixing belt 10 at a predetermined speed (in a narrow sense, the same speed).

In this case, the belt slip state may indicate a state in which a speed difference, which is a difference between the rotation speed of the fixing belt 10 and the rotation speed of the pressure roller 20, occurs. Also in this case, when one of the fixing belt 10 and the pressure roller 20 is rotated, the other cannot be sufficiently rotated, and thus there is a possibility that heat concentration occurs on the fixing belt 10. According to the method of the present embodiment, even when both the fixing belt 10 and the pressure roller 20 are driven in this way, it is possible to appropriately detect a state in which the both are not moving in conjunction with each other (a state in which the speed difference is large) as the belt slip state.

### 3.3 Sensor Arrangement

In the image forming apparatus 100 according to the present embodiment, as illustrated in FIGS. 4 and 5, the pressure member temperature detector (second thermistor 51) may be a non-contact type temperature sensor arranged at a position not in contact with the pressure member. With this configuration, it is possible to increase a degree of freedom in the arrangement of the pressure member detector.

However, the pressure member temperature detector is not limited to the non-contact type temperature sensor, and may be a contact type temperature sensor. Further, in FIGS. 4 and 5, an example of the contact type temperature sensor is illustrated as the first thermistor 43 of the fixing belt temperature detector, but the first thermistor 43 may be a non-contact type temperature sensor.

It is desirable that the pressure member temperature detector and the fixing belt temperature detector are disposed in such a way as to be able to acquire temperatures of the fixing belt 10 and the pressure roller 20 at positions opposed to each other, for example, in a main scanning direction (the front/back direction in FIG. 4, a direction along the longitudinal direction of the fixing belt 10 and the pressure roller 20) orthogonal to the sheet conveyance direction. By disposing the temperature detectors at the opposed positions in this way, it is possible to detect a relationship between the temperatures of the fixing belt 10 and the pressure roller 20 at the positions where the fixing belt 10 and the pressure roller 20 are in contact with each other and directly transfer heat. As a result, it is possible to suppress a decrease in the degree of following to which the pressure member temperature information follows the fixing belt temperature information due to a difference in position in the main scanning direction. In other words, it is possible to suppress a factor other than the belt slip state from being involved in the degree of following to which the pressure member temperature information follows the fixing belt temperature information, and thus it is possible to increase the determination accuracy of the belt slip state. For example, in FIG. 5, the fixing belt temperature detector may be the first thermopile 41, and the pressure member temperature detector may be the second thermistor 51.

Although the present embodiment has been described above in detail, those skilled in the art will easily understand that many modifications can be made within a range not substantially departing from new matters and effects of the present embodiment. Therefore, all such modifications are included in the scope of the present disclosure. For example, a term described in the specification or drawings at least once together with a term having a broader meaning or the same meaning may be replaced with the different term anywhere in the specification or drawings. All combinations of the present embodiment and modifications are also included in the scope of the present disclosure. In addition, the configurations, operations, and the like of the image forming apparatus, the image former, the fixing device, and the like are not limited to those described in the present embodiment, and various modifications can be made.

What is claimed is:

1. An image forming apparatus comprising:
a fixing belt;
a pressure member that forms a nip portion with the fixing belt and drives the fixing belt;
a heating member disposed inside the fixing belt;
a fixing belt temperature detector that acquires fixing belt temperature information based on a temperature of the fixing belt;
a pressure member temperature detector that acquires pressure member temperature information based on a temperature of the pressure member; and
one or more controllers that determine whether or not the fixing belt is in a belt slip state where the fixing belt is not driven by movement of the pressure member, based on a relationship between the fixing belt temperature information and the pressure member temperature information.

2. The image forming apparatus according to claim 1, wherein
the one or more controllers determine whether or not the fixing belt is in the belt slip state, based on a change in the fixing belt temperature information per unit time and a change in the pressure member temperature information per unit time.

3. The image forming apparatus according to claim 2, wherein
the one or more controllers determine that the fixing belt is in the belt slip state when a state where an amount of change in the fixing belt temperature information per unit time is determined to be equal to or greater than a first change amount threshold value and an amount of change in the pressure member temperature information per unit time is determined to be equal to or greater than a second change amount threshold value is detected a predetermined number of times or more.

4. The image forming apparatus according to claim 3, wherein
the one or more controllers determine that an abnormality other than the belt slip state occurs when it is determined that the amount of change in the fixing belt temperature information per unit time is equal to or greater than the first change amount threshold value and when it is determined that the amount of change in the pressure member temperature information per unit time is less than the second change amount threshold value.

5. The image forming apparatus according to claim 1, wherein
the one or more controllers determine a degree of following to which the pressure member temperature information follows the fixing belt temperature information, and determine that the fixing belt is in the belt slip state when it is determined that the degree of following is equal to or less than a given threshold value.

6. The image forming apparatus according to claim 5, wherein
the one or more controllers determine that an abnormality other than the belt slip state occurs or there is no abnormality when it is determined that the degree of following to which the pressure member temperature information follows the fixing belt temperature information is larger than the given threshold value.

7. The image forming apparatus according to claim 1, wherein
the one or more controllers determine whether or not the fixing belt is in the belt slip state, based on a thermal gradient represented by a difference between the fixing belt temperature information and the pressure member temperature information.

8. The image forming apparatus according to claim 7, wherein
the one or more controllers determine whether or not the fixing belt is in the belt slip state, based on a temporal change in the thermal gradient.

9. The image forming apparatus according to claim 1, wherein
the one or more controllers perform control to stop heating by the heating member and control to stop rotation of the fixing belt when it is determined that the fixing belt is in the belt slip state.

10. The image forming apparatus according to claim 1, wherein
the pressure member temperature detector is a non-contact type temperature sensor disposed at a position not in contact with the pressure member.

11. A control method of an image forming apparatus including a fixing belt, a pressure member that forms a nip portion with the fixing belt and drives the fixing belt, and a heating member disposed inside the fixing belt, the control method comprising:
acquiring fixing belt temperature information based on a temperature of the fixing belt;
acquiring pressure member temperature information based on a temperature of the pressure member; and
determining whether or not the fixing belt is in a belt slip state where the fixing belt is not driven by movement of the pressure member, based on a relationship between the fixing belt temperature information and the pressure member temperature information.
